(19) United States
(12) Patent Application Publication
(10) Pub. No.: US 2024/0031843 A1
(43) Pub. Date: Jan. 25, 2024

(54) TERMINAL AND COMMUNICATION METHOD

(71) Applicant: NTT DOCOMO, INC., Tokyo (JP)

(72) Inventors: Naoya Shibaike, Chiyoda-ku, Tokyo (JP); Hiroki Harada, Chiyoda-ku, Tokyo (JP); Satoshi Nagata, Chiyoda-ku, Tokyo (JP); Jing Wang, Haidian District, Beijing (CN)

(73) Assignee: NTT DOCOMO, INC., Tokyo (JP)

(21) Appl. No.: 18/255,935

(22) PCT Filed: Jan. 18, 2021
(86) PCT No.: PCT/JP2021/001538

§ 371 Date: Jun. 5, 2023

(51) Int. Cl. H04W 24/08

(52) U.S. Cl. CPC H04W 24/08

(57) ABSTRACT

A terminal includes a reception unit that receives a configuration for measuring a received signal strength indicator (RSSI) and a channel occupancy (CO) from a base station; a control unit that measures the RSSI and the CO for each of a plurality of reporting units based on the configuration; and a transmission unit that transmits a result of measurement for each of the plurality of reporting units to the base station.

### TECHNICAL FIELD

The present invention relates to a terminal and a communication method in a wireless communication system.

### BACKGROUND ART

In NR (New Radio) (also referred to as “5G”), which is a successor system of LTE (Long Term Evolution), a technology that satisfies requirements such as a large-capacity system, a high-speed data transmission rate, a low delay, simultaneous connection of a large number of terminals, low cost, and power saving has been discussed (See, for example, Non-patent document 1).

In NR Release 17, the use of a frequency band higher than that of a conventional release has been discussed (See, for example, Non-patent document 2). For example, applicable numerologies including subcarrier spacing, channel bandwidth, and the like in the frequency band of from 52.6 GHz to 71 GHz; physical layer designs; and failures assumed in actual wireless communications, have been discussed.

### RELATED ART DOCUMENT

### Non-Patent Document

Non-patent document 1: 3GPP TS 38.300 V16.3.0 (2020-09)
Non-patent document 2: 3GPP TS 38.306 V16.2.0 (2020-09)

### SUMMARY OF THE INVENTION

### Problems to be Solved by the Invention

In a newly operated frequency band using a frequency that is higher than that of the conventional frequency band, it is assumed that a larger sub-carrier spacing (SCS) is used and a larger number of beams are used. Therefore, there is a possibility that sufficient information necessary for communication control in the frequency band using the higher frequency cannot be acquired by the conventional measurement method.

The present invention has been made in view of the above-described points, and enables measurement to be performed according to a frequency band in a wireless communication system.

### Means for Solving the Problem

According to the disclosed technology, there is provided a terminal including: a reception unit that receives a configuration for measuring a received signal strength indicator (RSSI) and a channel occupancy (CO) from a base station; a control unit that measures the RSSI and the CO for each of a plurality of reporting units based on the configuration; and a transmission unit that transmits a result of measurement for each of the plurality of reporting units to the base station.

### Effect of the Invention

According to the disclosed technology, it is possible to perform measurement according to a frequency band in a wireless communication system.

### BRIEF DESCRIPTION OF DRAWINGS

FIG. 1 is a drawing illustrating an example of a structure of a wireless communication system according to an embodiment of the present invention.

FIG. 2 is a drawing illustrating an example of a frequency range according to the embodiment of the present invention.

FIG. 3 is a drawing illustrating an example of sensing.

FIG. 4 is a drawing illustrating an example of a communication environment.

FIG. 5 is a flowchart illustrating measurement according to the embodiment of the present invention.

FIG. 6 is a drawing illustrating an example of a functional structure of a base station according to the embodiment of the present invention.

FIG. 7 is a drawing illustrating an example of a functional structure of a terminal 20 according to the embodiment of the present invention.

FIG. 8 is a drawing illustrating an example of a hardware structure of the base station or the terminal 20 according to the embodiment of the present invention.

### MODE FOR CARRYING OUT THE INVENTION

Hereinafter, embodiments of the present invention will be described with reference to the drawings. It should be noted that the embodiments described below are merely examples, and embodiments to which the present invention is applied are not limited to the following embodiments.

With respect to the operation of the wireless communication system according to the embodiment of the present invention, existing technology is used as appropriate. However, the existing technology is, for example, an existing LTE, but is not limited to the existing LTE. In addition, the term “LTE” used in the specification of the present application has a broad meaning including LTE-Advanced and schemes after LTE-Advanced (for example, NR) unless otherwise specified.

In addition, in the embodiments of the present invention described below, terms used in the existing LTE, such as SS (Synchronization Signal), PSS (Primary SS), SSS (Secondary SS), PBCH (Physical Broadcast CHannel), PRACH (Physical Random Access CHannel), PDCCH (Physical Downlink Control CHannel), PDSCH (Physical Downlink Shared CHannel), PUCCH (Physical Uplink Control CHannel), and PUSCH (Physical Uplink Shared CHannel) will be used. This is for convenience of description, and signals, functions, and the like similar to them may be referred to by other names. Also, the above terms in the NR correspond to NR-SS, NR-PSS, NR-SSS, NR-PBCH, NR-PRACH, and the like. However, even a signal used for the NR is not necessarily specified as “NR-”.

Further, in the embodiments of the present invention, the duplex scheme may be a TDD (Time Division Duplex) scheme, an FDD (Frequency Division Duplex) scheme, or another scheme (for example, Flexible Duplex scheme).

In addition, in the embodiment of the present invention, “configuring” a radio parameter may mean pre-configuring a predetermined value or configuring a radio parameter indicated by a base station 10 or a terminal 20.

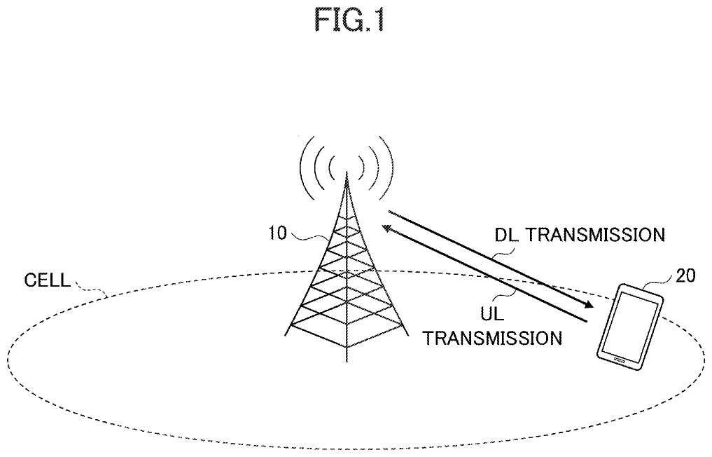

FIG. 1 is a drawing illustrating an example of a structure of the wireless communication system according to the embodiment of the present invention. As shown in FIG. 1, the wireless communication system according to the embodiment of the present invention includes the base station 10 and the terminal 20. Although one base station 10 and one terminal 20 are shown in FIG. 1, this is merely an example, and a plurality of base stations 10 and a plurality of terminals 20 may be provided.

The base station 10 is a communication apparatus that provides one cell or two or more cells and performs wireless communication with the terminal 20. A physical resource of a radio signal is defined in a time domain and a frequency domain. The time domain may be defined by an orthogonal frequency division multiplexing (OFDM) symbol number. The frequency domain may be defined by a number of subcarriers or a number of resource blocks. The base station 10 transmits a synchronization signal and system information to the terminal 20. The synchronization signal is, for example, an NR-PSS and an NR-SSS. The system information is transmitted in an NR-PBCH, for example, and is also referred to as broadcast information. The synchronization signal and the system information may be referred to as an SSB (SS/PBCH block). As shown in FIG. 1, the base station 10 transmits a control signal or data to the terminal 20 in downlink (DL), and receives a control signal or data from the terminal 20 in uplink (UL). Both the base station 10 and the terminal 20 are capable of transmitting and receiving signals by performing beamforming. In addition, both the base station 10 and the terminal 20 can apply communication by MIMO (Multiple Input Multiple Output) to the DL or the UL. Also, both the base station 10 and the terminal 20 may perform communication via a secondary cell (SCell) by carrier aggregation (CA) and a primary cell (PCell). Furthermore, the terminal 20 may perform communication via a primary cell of the base station 10 by DC (Dual Connectivity) and a primary secondary cell group cell (PSCell (Primary SCG Cell)) of another base station 10.

The terminal 20 is a communication apparatus having a wireless communication function, such as a smartphone, a mobile phone, a tablet, a wearable terminal, or an M2M (Machine-to-Machine) communication module. As shown in FIG. 1, the terminal 20 uses various communication services provided by the wireless communication system, by receiving a control signal or data from the base station 10 in DL and transmitting a control signal or data to the base station 10 in UL. In addition, the terminal 20 receives various reference signals transmitted from the base station 10, and measures channel quality based on results of the reception of the reference signals.

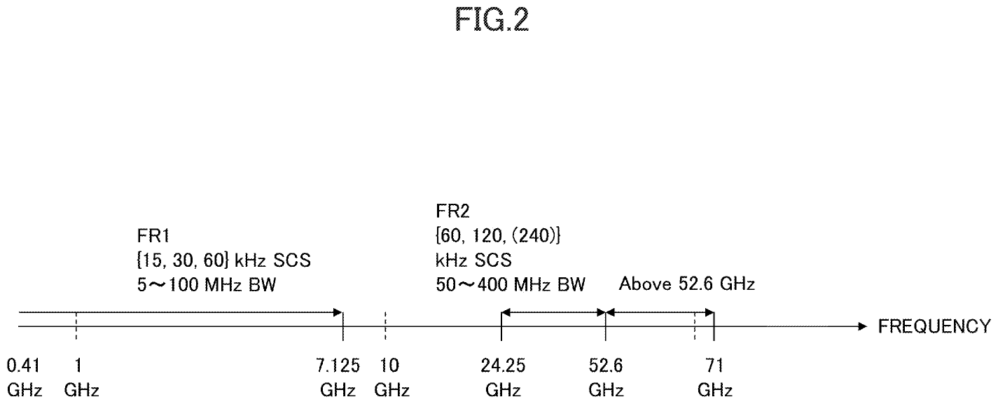

FIG. 2 is a drawing illustrating an example of a frequency range according to the embodiment of the present invention. In the NR specifications of 3GPP Release 15 and Release 16, for example, operation in a frequency band of 52.6 GHz or higher has been discussed. As shown in FIG. 2, FR (Frequency range) 1 for which the current operation is defined is a frequency band from 410 MHz to 7.125 GHz. In FR1, SCS (Sub carrier spacing) is 15, 30, or 60 kHz, and the bandwidth is from 5 MHz to 100 MHz. FR2 is a frequency band from 24.25 GHz to 52.6 GHz. In FR2, SCS is 60, 120, or 240 kHz, and the bandwidth is from 50 MHz to 400 MHz. For example, the newly operated frequency band may be assumed to be from 52.6 GHz to 71 GHz.

In the newly operated frequency band, the physical layer processing procedure adopts a channel access mechanism assuming a beam-based operation in order to satisfy a requirement of regulation applied to the unlicensed band from 52.6 Gz to 71 GHz. For example, procedures related to LBT (Listen before talk) and non-LBT, and non-LBT that does not require an additional sensing mechanism have been discussed. Also, receiver support in Omni-directional LBT, Directional LBT, and channel access has been discussed. In addition, a threshold value for detecting power has been discussed. The operation of the unlicensed band in NR may be referred to as NR-U.

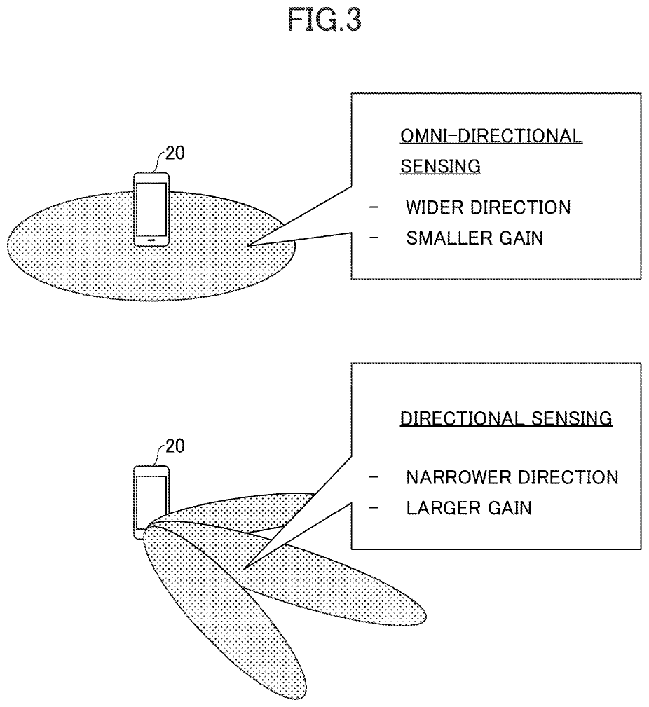

FIG. 3 is a drawing illustrating an example of sensing. In order to compensate for a large propagation loss in the newly operated frequency band, a narrower beam is assumed to be applied to transmission. Here, LBT is performed in order to satisfy the requirement of regulation in the unlicensed band. The LBT means sensing to check whether or not a channel is occupied before starting transmission. Reception beam forming is applied to sense beams. As shown in FIG. 3, the Omni-directional sensing enables sensing in a wider direction and has a smaller gain compared to the Directional sensing. On the other hand, the Directional sensing enables sensing in a narrower direction and has a larger gain compared to the Omni-directional sensing.

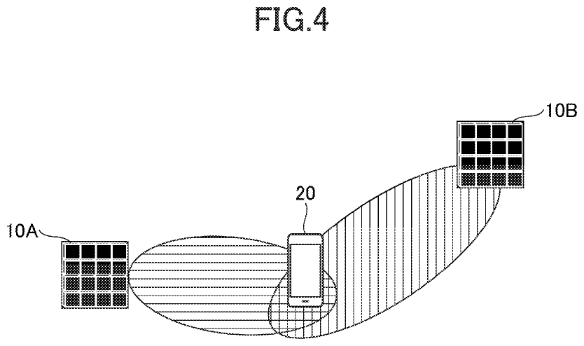

FIG. 4 is a drawing illustrating an example of a communication environment. Because the beam is applied, it is assumed that a hidden node problem occurs in which interference is detected in a reception-side device but is not detected in a transmission-side device. For example, as shown in FIG. 4, the terminal 20 detects that transmission from a base station 10A and transmission from a base station 10B interfere with each other. However, the base station 10A or the base station 10B cannot detect that the transmission from the base station itself causes interference at the terminal 20.

The conventional measurement methods in NR-U include measuring Received Signal Strength Indicator (RSSI), and measuring channel occupancy (CO). The terminal 20 reports a measured RSSI in a unit of dBm. The terminal 20 reports a channel occupancy indicating a ratio of samples in which the RSSI exceeds a configured threshold.

The configuration for measurement of RSSI and CO may be referred to as an RSSI measurement timing configuration (RMTC). For example, the RMTC includes a period of measurement, an offset, a measurement time, a measurement frequency, and a referenced SCS.

For example, the measurement time for RSSI may be calculated based on a configured number of symbols and a configured SCS. In addition, an RSSI report value may be an average of sample values provided by the lower layer. In addition, the CO may be a ratio of samples with values exceeding the configured threshold.

Here, in the conventional measurement and report of RSSI and CO, characteristics of the newly introduced high frequency band have not been taken into account. For example, use of larger SCSs, i.e., 120 kHz, 240 kHz, and 480 kHz SCSs and 960 kHz SCS, and use of narrower beams have not been taken into account.

Therefore, at least the following items 1) to 3) may be applied to the measurement and the report of RSSI and CO in the NR 52.6 GHz to 71 GHz band.
1) New definition related to measurement time (period considering new SCS and multi-beam sensing)
2) New definition of report values
3) New method related to determination/calculation of report values.

FIG. 5 is a flowchart illustrating the measurement according to the embodiment of the present invention. In step S1, the terminal 20 receives a configuration related to measurement of RSSI and CO from a base station. In the subsequent step S2, the terminal 20 performs the measurement of RSSI and CO for a DL signal. In the subsequent step S3, the terminal 20 reports a result of the measurement of RSSI and CO to the base station.

The configuration related to the measurement of RSSI and CO in step S1 may include the configurations shown in the following items 1) to 5).
1) Larger SCSs may be added. For example, the SCSs of 120 kHz, 240 kHz, 480 kHz, and 960 kHz may be added as the referenced SCSs. Thus, a configuration applied to the operation of a larger SCS becomes possible.
2) The number of symbols indicating the measurement time may be added. For example, two symbols may be added, three symbols may be added, or five symbols may be added. Thus, a sensing period, in which 5 microseconds are secured for each SCS, can be configured. For example, a sensing period, in which 5 microseconds are secured by two symbols in 240 kHz SCS, by three symbols in 480 kHz SCS, and by five symbols in 960 kHz, can be configured.
3) The number of symbols indicating the measurement time in consideration of multiple beams may be added. For example, two symbols may be added, three symbols may be added, or five symbols may be added. For example, the measurement time may be defined as 2 symbols×X in 240 kHz SCS, 3 symbols×X in 480 kHz SCS, or 5 symbols×X in 960 kHz. X may be a number of beams used for the RSSI measurement. X may be determined based on an RRC configuration, a MAC-CE (Control Element) configuration, or an indication by DCI. Alternatively, one value may be defined in the specification.
4) A new measurement period may be added. For example, at least one of 5 ms, 10 ms, 20 ms, and ms may be added. Thus, a sensing period can be flexibly configured in accordance with the communication environment.
5) A configuration related to new sensing may be added. For example, only a beam corresponding to an active TCI (Transmission Configuration Indicator) state for PDCCH/PDSCH may be used for measurement. Thus, it is possible to configure the measurement of RSSI and CO by assuming the beam used for the DL reception. In addition, information related to a beam may be configured as a measurement target in the measurement of RSSI and CO or the report. Thus, flexible configuration becomes possible by measuring a beam. The information related to a beam may be, for example, a TCI state; a spatial relation; or information corresponding to a configuration of an SS/PBCH block (SSB), a channel state information-reference signal (CSI-RS), or a sounding reference signal (SRS).

As a result of the measurement in step S3, a plurality of values related to an RSSI average and/or CO may be reported. Thus, for example, the RSSI average and/or the CO can be reported for each beam, and the hidden node problem can be detected more accurately.

A reporting unit of the RSSI average and/or the CO in the report of the measurement result may be determined based on at least one of the following 1) to 8). The number in the following 1) to 8) may be one, or may be two or more.
1) The number of beams
2) The number of beams of SSB, CSI-RS or SRS
3) The number of configurations of SSB, CSI-RS or SRS
4) The total number of beams of SSB, CSI-RS or SRS
5) The total number of configurations of SSB, CSI-RS or SRS
6) The number of samples for each beam or installation of SSB, CSI-RS or SRS
7) The index of SSB, CSI-RS or SRS measured in each reporting unit
8) The index of SSB, CSI-RS or SRS measured in all reporting units

The reporting unit of the RSSI average and/or the CO in the report of the measurement result may be configurable based on UE capability signaling, the RRC configuration, the MAC-CE, or DCI indication.

The reporting unit of the RSSI average and/or the CO in the report of the measurement result may be limited. For example, the reporting unit may be a reporting unit corresponding to a limited beam. Also, for example, the reporting unit may be limited only to a beam corresponding to an active TCI state for PDCCH/PDSCH, or may always include a beam corresponding to the active TCI state for PDCCH/PDSCH. Thus, it is possible to configure the RSSI and CO measurement by assuming a beam used for DL reception. In addition, for example, the reporting unit may be limited to a beam or a set of beams, or may be limited to one or more values calculated based on a beam or a set of beams. Accordingly, it is possible to flexibly configure a beam corresponding to a value to be reported.

As the measurement result in step S3, the value related to the RSSI average and/or the CO calculated for each reporting unit may be reported.

The reporting unit of the RSSI average and/or the CO in the report of the measurement result may be determined based on at least one of the following 1) to 8). The number in each of the following 1) to 8) may be one, or may be two or more.
1) The number of beams
2) The number of beams of SSB, CSI-RS or SRS
3) The number of configurations of SSB, CSI-RS or SRS
4) The total number of beams of SSB, CSI-RS or SRS
5) The total number of configurations of SSB, CSI-RS or SRS
6) The number of samples for each beam or installation of SSB, CSI-RS or SRS
7) The index of SSB, CSI-RS or SRS measured in each reporting unit
8) The index of SSB, CSI-RS or SRS measured in all reporting units

The reporting unit of the RSSI average and/or the CO in the report of the measurement result may be configurable based on the UE capability signaling, the RRC configuration, the MAC-CE, or DCI indication.

As a configuration of the reporting unit of the measurement result, for example, only a beam corresponding to an active TCI state for PDCCH/PDSCH may be used for calculating the measurement result. Thus, it is possible to calculate the measurement of RSSI and CO by assuming the beam used for the DL reception. Also, for example, the measurements may be calculated based on a beam or a set of beams. Accordingly, it is possible to flexibly configure a beam corresponding to a value to be reported.

Note that in the present disclosure, an information element or a component of the information element may have any name.

According to the above-described embodiment, the base station 10 and the terminal 20 can perform measurement of RSSI and CO with high accuracy adapted to a frequency band to which an SCS larger than the conventional SCS is applied.

That is, in the wireless communication system, it is possible to perform measurement according to the frequency band.

### (Apparatus Structure)

Next, an example of a functional structure of the base station 10 and the terminal 20 that execute the processes and operations described above will be described. The base station 10 and the terminal 20 include functions for carrying out the above-described embodiments. However, each of the base station 10 and the terminal 20 may have only a part of the functions in the embodiment.

### <Base Station 10>

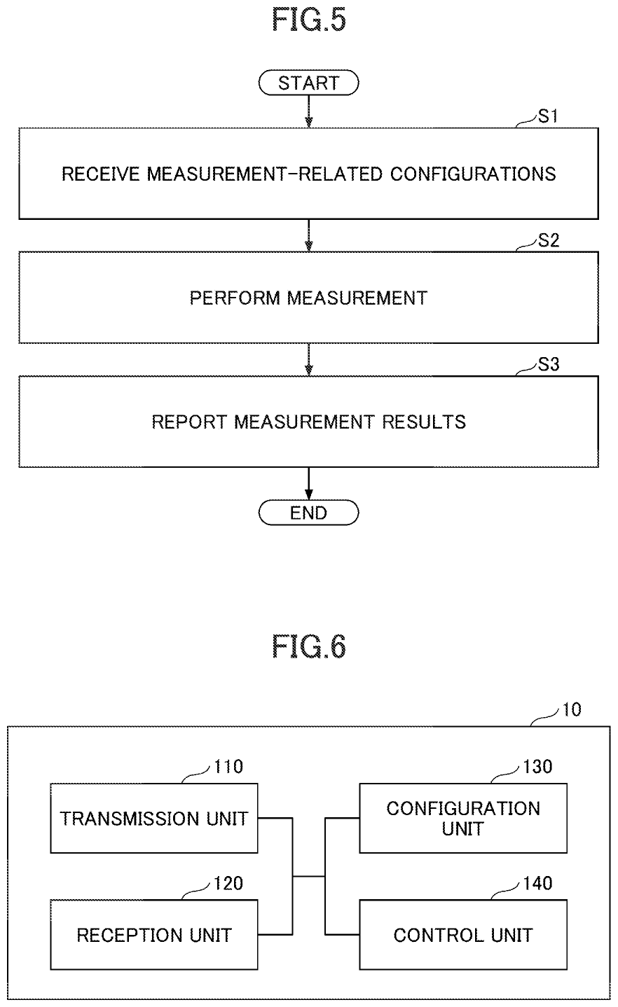

FIG. 6 is a drawing illustrating an example of a functional structure of the base station 10 according to the embodiment of the present invention. As shown in FIG. 6, the base station 10 includes a transmission unit 110, a reception unit 120, a configuration unit 130, and a control unit 140. The functional structure shown in FIG. 6 is merely an example. As long as the operation according to the embodiment of the present invention can be executed, any function division and any name of the function unit may be used.

The transmission unit 110 includes a function of generating a signal to be transmitted to the terminal 20 side and wirelessly transmitting the signal. The transmission unit 110 transmits an inter-network node message to another network node. The reception unit 120 includes a function of receiving various signals transmitted from the terminal 20 and acquiring, for example, information on a higher layer from the received signal. Further, the transmission unit 110 has a function of transmitting NR-PSS, NR-SSS, NR-PBCH, DL/UL control signals, or the like to the terminal 20. The reception unit 120 receives an inter-network node message from another network node.

The configuration unit 130 stores preset configuration information and various kinds of configuration information to be transmitted to the terminal 20. The content of the configuration information is, for example, information related to configuration of measurement.

The control unit 140 performs control related to the configuration of measurement as described in the embodiment. Further, the control unit 140 performs scheduling. A function unit related to the signal transmission in the control unit 140 may be included in the transmission unit 110, and a function unit related to the signal reception in the control unit 140 may be included in the reception unit 120.

### <Terminal 20>

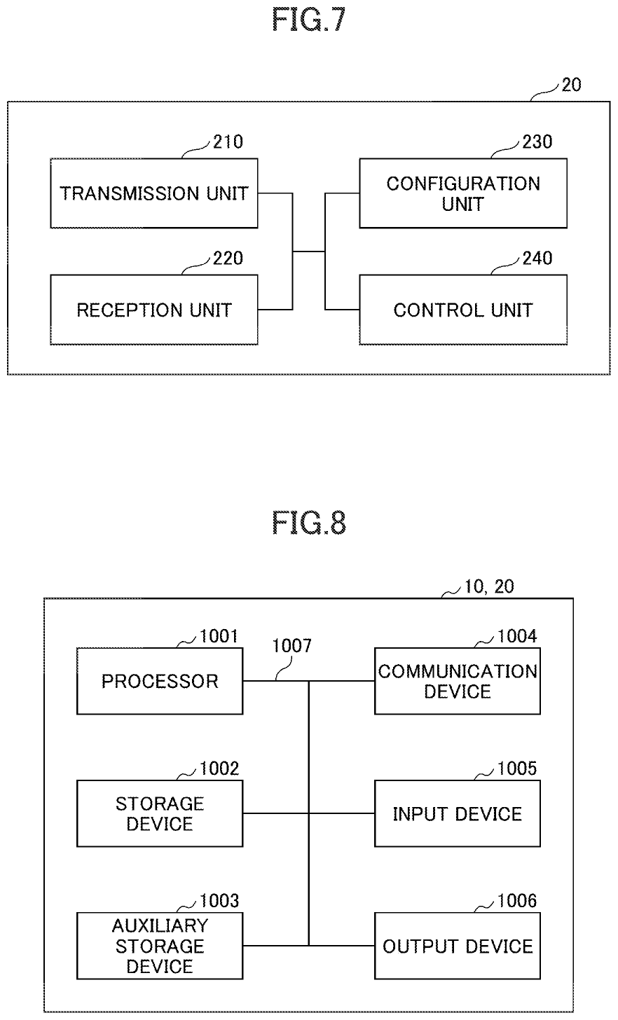

FIG. 7 is a drawing illustrating an example of a functional structure of the terminal 20 according to the embodiment of the present invention. As shown in FIG. 7, the terminal 20 includes a transmission unit 210, a reception unit 220, a configuration unit 230, and a control unit 240. A functional structure shown in FIG. 7 is merely an example. As long as the operation according to the embodiment of the present invention can be executed, any function division and any name of the function unit may be used.

The transmission unit 210 generates a transmission signal from transmission data and wirelessly transmits the transmission signal. The reception unit 220 wirelessly receives various signals and acquires a signal of a higher layer from the received signal of the physical layer. In addition, the reception unit 220 has a function of receiving NR-PSS, NR-SSS, NR-PBCH, DL/UL/SL control signals, or the like transmitted from the base station 10. In addition, for example, the transmission unit 210 transmits a physical sidelink control channel (PSCCH), a physical sidelink shared channel (PSSCH), a physical sidelink discovery channel (PSDCH), a physical sidelink broadcast channel (PSBCH), or the like to the other terminal in D2D communication, and the reception unit 220 receives a PSCCH, a PSSCH, a PSDCH, a PSBCH, or the like from the other terminal 20.

The configuration unit 230 stores various types of configuration information received by the reception unit 220 from the base station 10. The configuration unit 230 also stores configuration information that is configured in advance. The content of the configuration information is, for example, information related to the configuration of measurement.

The control unit 240 performs control related to the configuration of measurement, as described in the embodiment. A function unit related to the signal transmission in the control unit 240 may be included in the transmission unit 210, and a function unit related to the signal reception in the control unit 240 may be included in the reception unit 220.

### (Hardware Structure)

The block diagrams (FIGS. 6 and 7) used in the description of the above-described embodiments show blocks as units of function. These functional blocks (configuration units) are realized by an optional combination of hardware, software, or both. In addition, a method of realizing each functional block is not particularly limited. That is, each functional block may be realized by using one apparatus that is physically or logically coupled, or may be realized by two or more apparatuses which are physically or logically separated and connected directly or indirectly (for example, using a wire, or wirelessly) to each other. The functional blocks may be realized by combining software with the one apparatus or the plurality of apparatuses.

The functions include determining, judging, deciding calculating, computing, processing, deriving, investigating, searching, ascertaining, receiving, transmitting, outputting, accessing, resolving, selecting, choosing, establishing, comparing, assuming, expecting, deeming, broadcasting, notifying, communicating, forwarding, configuring, reconfiguring, allocating, mapping, assigning, and the like, but are not limited to them. For example, a functional block (component) that causes transmission to function is referred to as a transmission unit or a transmitter. In either case, as described above, the realization method is not particularly limited.

For example, the base station 10, the terminal 20, and the like according to the embodiment of the present disclosure may function as a computer that performs processing of the wireless communication method according to the present disclosure. FIG. 8 is a drawing illustrating an example of a hardware structure of the base station and the terminal 20 according to the embodiment of the present disclosure. The base station 10 and the terminal 20 described above may be physically structured as a computer apparatus including a processor 1001, a storage device 1002, an auxiliary storage device 1003, a communication device 1004, an input device 1005, an output device 1006, a bus 1007, and the like.

In the following description, the word “apparatus” can be read as a circuit, a device, a unit, or the like. The hardware structure of the base station 10 and the terminal 20 may be structured to include one of the apparatuses or two or more of the apparatuses shown in the drawings, or may be structured so that a part of the apparatuses is omitted.

Each function in the base station 10 and the terminal 20 is realized by causing hardware, such as the processor 1001 or the storage device 1002, to read predetermined software (program), and causing the processor 1001 to perform arithmetic operations to control communication by the communication device 1004 or to control reading, writing, or both of data in the storage device 1002 and the auxiliary storage device 1003.

The processor 1001 operates, for example, an operating system to control the entire computer. The processor 1001 may include a central processing unit (CPU) including an interface with a peripheral apparatus, a control apparatus, an arithmetic apparatus, a register, and the like. For example, the above-described control unit 140, and the control unit 240 may be realized by the processor 1001.

In addition, the processor 1001 reads out a program (program code), a software module, data, or the like from the auxiliary storage device 1003, the communication device 1004, or both to the storage device 1002, and executes various processes in accordance with the program, the software module, the data, or the like. As the program, a program that causes a computer to execute at least a part of the operations described in the above-described embodiment is used. For example, the control unit 140 of the base station 10 shown in FIG. 6 may be realized by a control program stored in the storage device 1002 and operating in the processor 1001. In addition, for example, the control unit 240 of the terminal 20 shown in FIG. 7 may be realized by a control program stored in the storage device 1002 and operating in the processor 1001. Although it has been described that the above-described various processes are executed by the one processor 1001, the processes may be executed by two or more processors 1001 simultaneously or sequentially. The processor 1001 may be implemented by one chip or by two or more chips. The program may be transmitted from a network via an electric communication line.

The storage device 1002 is a computer-readable recording medium, and may include, for example, at least one of a read only memory (ROM), an erasable programmable ROM (EPROM), an electrically erasable programmable ROM (EEPROM), and a random access memory (RAM). The storage device 1002 may be referred to as a register, a cache, a main memory (main storage apparatus), or the like. The storage device 1002 can store programs (program codes), software modules, and the like that are executable to carry out the communication method according to the embodiment of the present disclosure.

The auxiliary storage device 1003 is a computer-readable recording medium, and may include, for example, at least one of an optical disk such as a compact disc ROM (CD-ROM), a hard disk drive, a flexible disk, a magneto-optical disk (for example, a compact disk, a digital versatile disk, or a Blu-ray (registered trademark) disk), a smart card, a flash memory (for example, a card, a stick, or a key drive), a floppy (registered trademark) disk, and a magnetic strip. The above-described storage medium may be, for example, a database including the storage device 1002, the auxiliary storage device 1003, or both; a server; or any other appropriate medium.

The communication device 1004 is hardware (transmission/reception device) for performing communication between computers via a wired network, a wireless network, or both, and is also referred to as, for example, a network device, a network controller, a network card, or a communication module. The communication device 1004 may be structured to include a high-frequency switch, a duplexer, a filter, a frequency synthesizer, or the like in order to realize, for example, frequency division duplex (FDD), time division duplex (TDD), or both. For example, a transmission/reception antenna, an amplification unit, a transmission/reception unit, or a transmission path interface may be realized by the communication device 1004. The transmission/reception unit may be implemented such that a transmission unit and a reception unit are physically or logically separated from each other.

The input device 1005 is an input device (for example, a keyboard, a mouse, a microphone, a switch, a button, or a sensor) that accepts an input from outside. The output device 1006 is an output device (for example, a display, a speaker, or an LED lamp) that performs an output to the outside. The input device 1005 and the output device 1006 may be served as an integrated structure (for example, a touch panel).

In addition, each apparatus such as the processor 1001 and the storage device 1002 is connected by a bus 1007 for communicating information. The bus 1007 may be structured using one bus, or may be structured using a different bus for each apparatus.

The base station 10 and the terminal 20 may be structured including hardware such as a microprocessor, a digital signal processor (DSP), an application specific integrated circuit (ASIC), a programmable logic device (PLD), or a field programmable gate array (FPGA), and a part or all of each functional block may be realized by the hardware. For example, the processor 1001 may be implemented using at least one of these pieces of hardware.

### Summary of Embodiment

As described above, according to the embodiment of the present invention, there is provided a terminal including: a reception unit that receives a configuration for measuring a received signal strength indicator (RSSI) and a channel occupancy (CO) from a base station; a control unit that measures the RSSI and the CO for each of a plurality of reporting units based on the configuration; and a transmission unit that transmits a result of measurement for each of the plurality of reporting units to the base station.

With the above-described structure, the base station 10 and the terminal 20 can perform highly accurate RSSI and CO measurement adapted to a frequency band to which an SCS larger than the conventional SCS is applied. That is, in the wireless communication system, it is possible to perform measurement according to the frequency band.

The reporting unit may be one or more beams. With this structure, the base station 10 and the terminal 20 can perform, for each beam, highly accurate RSSI and CO measurement, which is adapted to a frequency band to which an SCS larger than the conventional SCS is applied.

The beams may correspond to an SS/PBCH block (SSB), a channel state information-reference signal (CSI-RS), or a sounding reference signal (SRS). With this structure, the base station 10 and the terminal 20 can perform, for each beam, highly accurate RSSI and CO measurement, which is adapted to a frequency band to which an SCS larger than the conventional SCS is applied.

The reporting unit may include one beam corresponding to an active transmission configuration indicator (TCI) state. With this structure, the base station 10 and the terminal 20 can perform highly accurate RSSI and CO measurement corresponding to a downlink transmission beam, which is adapted to a frequency band to which an SCS larger than the conventional SCS is applied.

The control unit may perform the measurement based on a measurement time having a different number of symbols for each subcarrier spacing. With the above-described structure, the base station 10 and the terminal 20 can perform highly accurate RSSI and CO measurement adapted to a frequency band to which an SCS larger than the conventional SCS is applied.

According to the embodiment of the present invention, there is provided a communication method executed by a terminal. The communication method includes: receiving a configuration for measuring a received signal strength indicator (RSSI) and a channel occupancy (CO) from a base station; measuring the RSSI and the CO for each of a plurality of reporting units based on the configuration; and transmitting a result of measurement for each of the plurality of reporting units to the base station.

With the above-described structure, the base station 10 and the terminal 20 can perform highly accurate RSSI and CO measurement adapted to a frequency band to which an SCS larger than the conventional SCS is applied. That is, in the wireless communication system, it is possible to perform measurement according to the frequency band.

### Supplementary Explanation of Embodiment

Although the embodiment of the present invention has been described above, the disclosed invention is not limited to the embodiment, and those skilled in the art will understand various variations, modifications, alterations, substitutions, and the like. Although the embodiment has been described using specific numerical examples in order to facilitate understanding of the present invention, these numerical values are merely examples and any appropriate values may be used unless otherwise specified. The division of items in the above description is not essential to the present invention. Matters described in two or more items may be combined as necessary to be used, and a matter described in one item may be applied to a matter described in another item (as long as there is no contradiction). A boundary between the function units or between the processing units in the functional block diagram does not necessarily correspond to a boundary between physical components. The operations of the plurality of function units may be performed by physically one component, or the operation of one function unit may be performed by physically plural components. With respect to the processing procedure described in the embodiment, the order of processing may be changed as long as there is no contradiction. For convenience of describing the processing, the base station 10 and the terminal 20 have been described using functional block diagrams. However, such apparatuses may be realized by hardware, software, or a combination thereof. Software executed by the processor included in the base station 10 according to the embodiment of the present invention and software executed by the processor included in the terminal 20 according to the embodiment of the present invention may be stored, respectively, in any appropriate storage medium such as a random access memory (RAM), a flash memory, a read-only memory (ROM), an EPROM, an EEPROM, a register, a hard disk (HDD), a removable disk, a CD-ROM, a database, or a server.

The indication of information is not limited to the aspects/embodiments described in the present disclosure, and may be performed using other methods. For example, the indication of the information may be performed by physical layer signaling (for example, downlink control information (DCI), or uplink control information (UCI)), higher layer signaling (for example, radio resource control (RRC) signaling, medium access control (MAC) signaling, notice information (master information block (MIB), or system information block (SIB)), other signals, or a combination thereof. In addition, the RRC signaling may be referred to as an RRC message, and may be, for example, an RRC connection setup message, or an RRC connection reconfiguration message.

Each aspect/embodiment described in the present disclosure may be applied to a system using Long Term Evolution (LTE), LTE-Advanced (LTE-A), SUPER 3G, IMT-Advanced, 4th generation mobile communication system (4G), 5th generation mobile communication system (5G), Future Radio Access (FRA), New Radio (NR), W-CDMA (trademark registered), GSM (trademark registered), CDMA2000, Ultra Mobile Broadband (UMB), IEEE 802.11 (Wi-Fi (trademark registered)), IEEE 802.16 (WiMAX (trademark registered)), IEEE 802.20, Ultra-WideBand (UWB), Bluetooth (trademark registered), and other appropriate systems; a next-generation system extended based on them; or both. In addition, the plurality of systems may be combined (for example, a combination of 5G and LTE, LTE-A, or both), and applied.

The order of the processing procedures, sequences, flowcharts, and the like of each aspect/embodiment described in the specification of the present application may be changed as long as there is no contradiction. For example, the methods described in the present disclosure use exemplary orders to present elements of the various steps, and are not limited to the specific order that is presented.

A specific operation described in the specification of the present application as being performed by the base station 10 may be performed by an upper node of the base station 10, in some cases. In a network including one network node or two or more network nodes each including the base station it is apparent that various operations performed for communication with the terminal 20 may be performed by at least one of the base station 10 and other network nodes (including, for example, an MME, or an S-GW, but being not limited to them) other than the base station 10. In the above, a case where there is one network node other than the base station 10 has been exemplified. However, the other network node may be a combination of a plurality of other network nodes (for example, an MME and an S-GW).

Information, a signal, or the like described in the present disclosure may be output from a higher layer (or a lower layer) to a lower layer (or a higher layer). The information, the signal, or the like may be input and output via a plurality of network nodes.

The input/output information or the like may be stored in a specific location (for example, a memory) or may be managed using a management table. The input/output information or the like may be overwritten, updated, or appended. The output information or the like may be deleted. The input information or the like may be transmitted to another apparatus.

The determination in the present disclosure may be performed by a value represented by one bit (0 or 1), may be performed by a Boolean value (true or false), or may be performed by comparing a numerical value (for example, comparing with a predetermined value).

Software shall be construed broadly to mean instructions, instruction sets, code, code segments, program code, programs, subprograms, software modules, applications, software applications, software packages, routines, subroutines, objects, executable files, execution threads, procedures, functions, and the like, regardless of whether referred to as software, firmware, middleware, microcode, hardware description language, or other names.

Software, instructions, information, or the like may also be transmitted and received over a transmission medium. For example, in the case where the software is transmitted from a website, a server, or the other remote source using a wired technology (coaxial cable, optical fiber cable, twisted pair, or digital subscriber line (DSL)), a wireless technology (infrared, microwave, etc.), or both, the wired technology, the wireless technology, or both is included in the definition of transmission medium.

Information, signals, and the like described in the present disclosure may be represented using any of a variety of different technologies. For example, data, instructions, commands, information, signals, bits, symbols, chips, and the like that may be referred to throughout the above description may be represented by voltages, currents, electromagnetic waves, magnetic fields or magnetic particles, optical fields or photons, or any combination thereof.

The terms described in the present disclosure and the terms necessary for understanding the present disclosure may be replaced with terms having the same or similar meanings. For example, a channel, a symbol, or both may be a signal (signaling). A signal may also be a message. Also, a component carrier (CC) may be referred to as a carrier frequency, a cell, a frequency carrier, or the like.

The terms “system” and “network” used in the present disclosure are used interchangeably.

In addition, the information, the parameter, and the like described in the present disclosure may be represented by using an absolute value, may be represented by using a relative value from a predetermined value, or may be represented by using another corresponding information. For example, the radio resource may be indicated by an index.

The names used for the above-mentioned parameters are not limited names in any respect. Furthermore, equations or the like that use these parameters may differ from those explicitly disclosed in the present disclosure. The various channels (e.g., PUCCH, or PDCCH) and information elements may be identified by any suitable name, and thus the various names assigned to these various channels and information elements are not limited names in any respect.

In the present disclosure, terms such as “Base Station (BS)”, “radio base station”, “base station apparatus”, “fixed station”, “NodeB”, “eNodeB (eNB)”, “gNodeB (gNB)”, “access point”, “transmission point”, “reception point”, “transmission/reception point”, “cell”, “sector”, “cell group”, “carrier”, and “component carrier” may be used interchangeably. A base station may also be referred to with the term, such as a macro cell, a small cell, a femto cell, or a pico cell.

The base station can accommodate one cell or two or more (e.g., three) cells. When a base station accommodates a plurality of cells, an entire coverage area of the base station may be divided into a plurality of smaller areas, and each smaller area may also provide a communication service by a base station subsystem (for example, an indoor small base station (Remote Radio Head (RRH)). The term “cell” or “sector” refers to a part of or an entire coverage area of the base station, the base station subsystem, or both providing the communication service in this coverage.

In the present disclosure, the terms such as “Mobile Station (MS)”, “user terminal”, “User Equipment (UE)”, and “terminal” may be used interchangeably.

The mobile station may also be referred to by those skilled in the art as a subscriber station, a mobile unit, a subscriber unit, a wireless unit, a remote unit, a mobile device, a wireless device, a wireless communication device, a remote device, a mobile subscriber station, an access terminal, a mobile terminal, a wireless terminal, a remote terminal, a handset, a user agent, a mobile client, a client, or some other suitable terms.

The base station, the mobile station, or both may be referred to as a transmission device, a reception device, a communication device, or the like. Note that the base station, the mobile station, or both may be a device mounted on a mobile body, the mobile body itself, or the like. The mobile body may be a vehicle (for example, a car, an airplane, or the like), a mobile body that moves without an operator (for example, a drone, an automatic driving vehicle, or the like), or a robot (manned or unmanned). The base station, the mobile station, or both includes a device that does not necessarily move during a communication operation. For example, the base station, the mobile station, or both may be an IoT (Internet of things) equipment such as a sensor.

Also, the base station in the present disclosure may be read as a user terminal. For example, each aspect/embodiment of the present disclosure may be applied to a structure in which communication between a base station and a user terminal is replaced with communication between a plurality of terminals 20, which may be referred to as D2D (Device-to-Device), or V2X (Vehicle-to-Everything), for example. In this case, the structure may be a structure in which the terminal has the function of the above-described base station 10. In addition, words such as “up” and “down” may be read as a word (for example, “side”) corresponding to terminal-to-terminal communication. For example, an uplink channel, or a downlink channel may be read as a side channel.

Similarly, the user terminal in the present disclosure may be read as a base station. In this case, the base station may be structured to have the function of the above-described user terminal.

The terms, such as “determining” and “determination” used in the present disclosure, may encompass a wide variety of operation. The terms “determining” and “determination” may include considering, for example, judging, calculating, computing, processing, deriving, investigating, looking up, searching, or inquiring (e.g., searching in a table, a database, or the other data structure), or ascertaining as “determining” or performing “determination”. Also, the terms “determining” and “determination” may include considering, receiving (e.g., receiving information), transmitting (e.g., transmitting information), input, output, accessing (e.g., accessing data in a memory) as “determining” or performing “determination”. In addition, the terms “determining” and “determination” may include considering resolving, selecting, choosing, establishing, comparing, or the like as “determining” or performing “determination”. That is, the terms “determining” and “determination” may include considering some operation as “determining” or performing “determination”. In addition, “determining (determination)” may be read as “assuming”, “expecting”, “considering”, or the like.

The terms, “connected”, “coupled”, or any variation thereof, refers to any connection or coupling, either direct or indirect, between two or more elements, and may include presence of an intermediate element or two or more intermediate elements between two elements that are “connected” or “coupled” to each other. The coupling or connection between elements may be physical, logical, or a combination thereof. For example, “connection” may be read as “access”. In the case of being used in the present disclosure, two elements may be considered to be “connected” or “coupled” to each other using one or more of at least one of a wire, a cable, and a printed electrical connection, and as some non-limiting and non-exhaustive examples, using electromagnetic energy having a wavelength in the radio frequency region, microwave region, and light (both visible and invisible) region.

The reference signal may be abbreviated as RS, and may be referred to as a pilot according to the applied standard.

The statement “based on” used in the present disclosure does not mean “based only on” unless expressly specified otherwise. In other words, the statement “based on” means both “based only on” and “based at least on”.

Any reference to an element using a designation such as “first”, “second”, or the like, used in the present disclosure, does not generally limit a quantity or an order of the elements. These designations may be used in the present disclosure as a convenient method of distinguishing between two or more elements. Thus, a reference to first and second elements means neither that only two elements may be employed nor that the first element must precede the second element in some form.

The term “means” in the structure of each apparatus described above may be replaced with “unit”, “circuit”, “device”, or the like.

In the case where the terms “include”, “including”, and a variation thereof are used in the present disclosure, these terms are intended to be inclusive in the same manner as the term “comprising”. Furthermore, the term “or” used in the present disclosure is not intended to be an exclusive OR.

A radio frame may be structured by one frame or two or more frames in the time domain. In the time domain, the one frame or each frame of the plurality of frames may be referred to as a subframe. The subframe may be further structured by one slot or two or more slots in the time domain. The subframe may be a fixed length of time (e.g., 1 ms) that is independent of a numerology.

The numerology may be a communication parameter applied to transmission, reception, or both of some signal or channel. The numerology may indicate, for example, at least one of a subcarrier spacing (SCS), a bandwidth, a symbol length, a cyclic prefix length, a transmission time interval (TTI), a number of symbols per TTI, a radio frame structure, a specific filtering process performed by a transceiver in the frequency domain, a specific windowing process performed by the transceiver in the time domain, and the like.

The slot may include one symbol (OFDM (Orthogonal Frequency Division Multiplexing) symbol, SC-FDMA (Single Carrier Frequency Division Multiple Access) symbol, and the like), or two or more symbols. The slot may be a time unit based on the numerology.

The slot may include a plurality of mini-slots. Each minislot may be structured by one symbol or two or more symbols in the time domain. The minislot may also be referred to as a subslot. The minislot may be structured by a smaller number of symbols than the slot. The PDSCH (or PUSCH) transmitted in a time unit larger than the minislot may be referred to as a PDSCH (or PUSCH) mapping type A. A PDSCH (or PUSCH) transmitted using the minislot may be referred to as a PDSCH (or PUSCH) mapping type B.

Each of the radio frame, the subframe, the slot, the minislot, and the symbol represents a time unit for transmitting a signal. For the radio frame, the subframe, the slot, the minislot, and the symbol, different names corresponding respectively to them may be used.

For example, one subframe may be referred to as a transmission time interval (TTI), a plurality of consecutive subframes may be referred to as a TTI, or one slot or one minislot may be referred to as a TTI. That is, the subframe, the TTI, or both may be a subframe (1 ms) in the existing LTE, may be a period shorter than 1 ms (for example, 1 to 13 symbols), or may be a period longer than 1 ms. Note that a unit representing the TTI may be referred to as a slot, a minislot, or the like instead of the subframe.

Here, the TTI refers to, for example, a minimum time unit of scheduling in wireless communication. For example, in the LTE system, a base station performs scheduling for allocating radio resources (a frequency bandwidth, transmission power, and the like that can be used in each terminal 20) to each terminal 20 in a unit of TTI. Note that the definition of TTI is not limited to this.

The TTI may be a transmission time unit, such as a channel-coded data packet (transport block), a code block, or a code word, or may be a processing unit, such as scheduling, or link adaptation. When a TTI is given, a time interval (for example, the number of symbols), to which a transport block, a code block, a code word, and the like are actually mapped, may be shorter than the TTI.

When one slot or one minislot is referred to as a TTI, one TTI or two or more TTIs (i.e., one slot or two or more slots, or one minislot or two or more minislots) may be a minimum time unit for scheduling. In addition, the number of slots (the number of minislots) structuring the minimum time unit of the scheduling may be controlled.

A TTI having a time length of 1 ms may be referred to as an ordinary TTI (a TTI in LTE Release 8 to 12), a normal TTI, a long TTI, an ordinary subframe, a normal subframe, a long subframe, a slot, or the like. A TTI that is shorter than the ordinary TTI may be referred to as a shortened TTI, a short TTI, a partial or fractional TTI, a shortened subframe, a short subframe, a minislot, a subslot, a slot, or the like.

Note that the long TTI (for example, the ordinary TTI, or the subframe) may be read as a TTI having a time length exceeding 1 ms, and the short TTI (for example, the shortened TTI) may be read as a TTI having a TTI length that is less than the TTI length of the long TTI and greater than or equal to 1 ms.

The resource block (RB) is a resource allocation unit in the time domain and the frequency domain, and may include one subcarrier or two or more contiguous subcarriers in the frequency domain. A number of subcarriers included in the RB may be the same regardless of the numerology, for example, 12. The number of subcarriers included in the RB may be determined based on the numerology. In addition, the time domain of the RB may include one symbol or two or more symbols, and may have a length of one slot, one mini-slot, one subframe, or one TTI. Each of the one TTI and the one subframe may include one resource block or two or more resource blocks.

Note that one RB or two or more RBs may be referred to as physical resource blocks (PRB), a sub-carrier group (SCG), a resource element group (REG), a PRB pair, an RB pair, or the like.

The resource block may be structured by a resource element (RE) or two or more REs. For example, one RE may be a radio resource region of one subcarrier and one symbol.

A bandwidth part (BWP), which may also be referred to as a partial bandwidth or the like, may indicate a subset of contiguous common resource blocks (common RBs) for some numerology in some carrier. Here, the common RB may be specified by an index of the RB with respect to a common reference point of the carrier. The PRB may be defined in some BWP and may be numbered within the BWP.

The BWP may include a BWP for UL (UL BWP) and a BWP for DL (DL BWP). For a UE, one BWP or two or more BWPs may be configured in one carrier.

At least one of the configured BWPs may be active and the UE may not assume to transmit or receive a predetermined signal/channel outside the active BWP. The terms “cell”, “carrier”, and the like in the present disclosure may be read as “BWP”.

The above-described structures of the radio frame, the subframe, the slot, the minislot, and the symbol are merely examples. For example, the number of subframes included in a radio frame, the number of slots per subframe or radio frame, the number of minislots included in a slot, the number of symbols and RBs included in a slot or a minislot, the number of subcarriers included in an RB, and structures such as the number of symbols, the symbol length, and the cyclic prefix (CP) length in a TTI can be changed in various ways.

In the present disclosure, for example, when articles are added by translation, such as “a”, “an”, and “the” in English, the present disclosure may include that nouns following these articles are plural.

In the present disclosure, the term “A and B are different” may mean that “A and B are different from each other”. It should be noted that the term may also mean that “A and B are each different from C”. Terms such as “separate”, “coupled”, and the like may also be similarly interpreted as “different”.

The aspect/embodiment described in the present disclosure may be used alone, may be used in combination, or may be switched to be used in accordance with execution. In addition, indication of predetermined information (for example, indication of “being X”) is not limited to being performed explicitly, and may be performed implicitly (for example, indication of the predetermined information is not performed).

The present disclosure has been described in detail as above. However, it will be apparent to those skilled in the art that the present disclosure is not limited to the embodiments described in the present disclosure. The present disclosure can be carried out as modified and changed aspects without departing from the spirit and scope of the present disclosure defined by the recitation of the claims. Accordingly, the description of the present disclosure is for illustrative purposes and is not meant to be in any way limiting to the present disclosure.

### DESCRIPTION OF REFERENCE SIGNS

10 Base station
110 Transmission unit
120 Reception unit
130 Configuration unit
140 Control unit
20 Terminal
210 Transmission unit
220 Reception unit
230 Configuration unit
240 Control unit
1001 Processor
1002 Storage device
1003 Auxiliary storage device
1004 Communication device
1005 Input device
1006 Output device

1. A terminal comprising:
a reception unit that receives a configuration for measuring a received signal strength indicator (RSSI) and a channel occupancy (CO) from a base station;
a control unit that measures the RSSI and the CO for each of a plurality of reporting units based on the configuration; and
a transmission unit that transmits a result of measurement for each of the plurality of reporting units to the base station.

2. The terminal according to claim 1, wherein
the reporting unit is one or more beams.

3. The terminal according to claim 2, wherein
the one or more beams correspond to an SS/PBCH block (SSB), a channel state information-reference signal (CSI-RS), or a sounding reference signal (SRS).

4. The terminal according to claim 2, wherein
the reporting unit includes one beam corresponding to an active transmission configuration indicator (TCI) state.

5. The terminal according to claim 1, wherein
the control unit performs measurement based on a measurement time having a different number of symbols for each subcarrier spacing.

6. A communication method executed by a terminal, the communication method comprising:
receiving a configuration for measuring a received signal strength indicator (RSSI) and a channel occupancy (CO) from a base station;
measuring the RSSI and the CO for each of a plurality of reporting units based on the configuration; and
transmitting a result of measurement for each of the plurality of reporting units to the base station.
